(19) United States
(12) Patent Application Publication
(10) Pub. No.: US 2005/0093911 A1
(43) Pub. Date: May 5, 2005

(54) Systems and methods for making defined orifice structures in fluid ejector heads and defined orifice structures

(75) Inventor: Gary A. Kneezel, Webster, NY (US)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/699,789

(22) Filed: Nov. 4, 2003

(51) Int. Cl. B41J 2/015

(52) U.S. Cl. 347/20

(57) ABSTRACT

In various exemplary embodiments of systems and methods according to this invention, fluid ejector is formed with orifice structures in fluid ejector print heads without defects, such as chipping of the orifice because dicing does not contact the orifice. A fluid ejector is formed with an orifice structure that can be formed in at least one layer of a fluid ejector head and the orifice structure is formed in such a way that the opening of the variously shaped orifice is offset forward or backward from the diced front face of the fluid ejector print head. The orifice structure allows dicing that does not contact the orifice structure.

### BACKGROUND OF THE INVENTION

1. Field of Invention

This invention is directed to a fluid ejector printer head of a fluid ejector system.

2. Description of Related Art

Fluid ejector systems, such as drop-on-demand liquid ink printers, such as piezoelectric, acoustic, phase change wax-based or thermal, have at least one fluid ejector from which droplets of fluid are ejected towards a receiving sheet. Side-shooter type ink jet print heads and other fluid ejectors contain orifice structures that are often made by dicing a wafer structure containing channel grooves. Such fluid ejector heads typically have three primary layers, a heater wafer containing bubble-nucleating heaters and related electronics, a polymer layer formed over the heater wafer, and a fluid inlet wafer that is bonded to the polymer layer.

Once the grooves are formed and channels are created by bonding the three primary layers together, the basic building block of the fluid ejector printer head is completed. Such bonding of three primary layers allows numerous fluid ejector print heads to be formed simultaneously. However, a fluid ejector print head is useless until each individual fluid ejector print head is diced from the wafer structure into a single print head module or die. Consequently, each fluid ejector print head must be diced out after the three wafer-scale layers are bonded together.

Typically, a specialized dicing blade is used to dice the bonded layers into each individual fluid ejector module. As part of the dicing operation, the blade is typically used to create cuts on the wafer that perpendicularly intersect the channels formed within the bonded wafers to create orifices from which fluids are ejected. The face containing the orifice structure is called the front face. The dicing operation forming the front face is called front face dicing.

Front face dicing of channel wafers, especially silicon fluid channel wafers, has disadvantages. For example, when dicing blades are used to intersect the channels and cut open the orifices at the front face, the abrasiveness of the dicing operation often cause the brittle wafer materials near the channels to break away, causing defects such as chipping of the orifice. Such chipped, and therefore defective, orifices degrade the performance of the fluid ejector print heads. For example, the accuracy of fluid ejectors suffers because fluid droplets tend to be misdirected according to the location and size of the chip. That is, fluid droplets tend to eject out of the chipped side of the orifice. Therefore, instead of being ejected perpendicularly to the front face, the fluid droplets may be ejected at a skewed angle to the front face.

To minimize misdirected fluid droplets, much effort has gone in to minimizing such chipping of the orifice by controlling and/or modifying the front face dicing operation. These efforts have been directed at developing blade compositions, varying rotational and/or feed speeds, and using dicing lubricants. However, such efforts to improve the dicing operation have not been able to completely eliminate the chipping.

### SUMMARY OF THE DISCLOSURE

For example, the types of blades which are often used in the dicing operation tend to be blades which have small diamonds embedded in a flexible resin mix. Such blades tend to bend slightly when pressure is applied during cutting and, therefore, are prone to cause positional errors during the dicing operation. Such flexible dicing blades cannot eliminate inaccurate placement of the dicing cut location on the front face that causes fluid drop volume and velocities to differ from each module or die and/or from each orifice. That is, fluid drop volume and velocities are affected by the distance between the heating element in the heater wafer and the actual orifice. This distance is determined by how accurately the cut that forms the orifice is placed when formed by the dicing blades. When an orifice is formed further from the heating element, the volume and the velocities of the fluid drop will decrease. The change in the fluid drop volume and velocities makes accurate and consistent fluid ejection difficult, leading to lower quality print heads.

Further, using dicing blades to expose the front of the orifice limits the shape of the channels and, by extension, the shape of the orifice. The cross-sectional area of the orifice has significant effect on fluid drop volume and velocity. If the channel walls near the orifice are nonparallel, then errors in cut placement result in a change in orifice cross-sectional area, which causes further variation in fluid drop volume and velocity. Consequently, using dicing blades to form the orifice does not allow for flexibility in channel and orifice designs.

This invention provides systems and methods for forming orifice structures in fluid ejector print heads.

This invention separately provides systems and methods for forming orifice structures in fluid ejector print heads with reduced defects.

This invention separately provides systems and methods for forming orifice structures in fluid ejector print heads with dicing blades that do not contact the orifice structure.

This invention separately provides systems and methods for forming orifice structures in fluid ejector print heads using a cross trench.

This invention separately provides systems and methods for forming orifice structures with desired shaped orifices in fluid ejector print heads.

This invention separately provides systems and methods of accurately forming orifice structures in fluid ejector print heads.

This invention separately provides a fluid ejector device with orifice structures having reduced defects.

This invention separately provides a fluid ejector device with orifice structures formed by dicing blades without contacting the orifice structure.

This invention separately provides a fluid ejector device with orifice structures formed using a cross trench.

This invention separately provides a fluid ejector device with orifice structures formed in desired shapes.

This invention separately provides a fluid ejector device with accurately formed orifices structures.

In various exemplary embodiments of systems, methods and fluid ejector devices according to his invention, orifice structures are formed in fluid ejector print heads with cross trenches. The cross trenches can be formed in at least one layer of a fluid ejector head. That is, the cross trenches can be formed in only one layer, or can be formed in more than one layer by combining grooves or trenches formed in individual layers or in portions of several layers. The cross trench is formed such that the orifice, i.e., the opening of the channel at the front face, is offset from a diced front face of the fluid ejector print head. The cross trench allows orifice structures to be formed without causing dicing defects to be formed in the orifice structure. The cross trench allows dicing that does not contact the orifice structure.

In various exemplary embodiments of systems, methods and fluid ejector devices according to this invention, orifice structures with flared orifices or tapered fluid ejector orifices can be formed. These specialized orifices are not damaged by the dicing operation because the openings of the orifices are offset from the diced front face. Further, because the exact placement of the orifice from the heater elements can be controlled by the size and location of the cross trench, rather than by the dicing operation, accurately formed orifice structures can be obtained.

These and other features and advantages of this invention are described in, or are apparent from the following detailed description of various exemplary embodiments of the systems, methods, and apparatus according to this invention.

### BRIEF DESCRIPTION OF THE DRAWINGS

Various exemplary embodiments of this invention will be described in detail, with reference to the following figures, wherein:

FIG. 1 shows some examples of defects in the orifice that are formed using conventional front face dicing;

FIG. 2 schematically illustrates one inaccurate dicing result;

FIG. 3 schematically illustrate another inaccurate dicing result;

FIG. 4 shows the general structure of a first exemplary embodiment of a channel wafer formed according to this invention;

FIG. 5 shows a general structure of a first exemplary embodiment of a front face of a fluid ejector formed using the channel wafer shown in FIG. 4;

FIG. 6 shows the general structure of a second exemplary embodiment of a channel wafer formed according to this invention;

FIG. 7 shows a general structure of a front face of the fluid ejector formed using the channel wafer shown in FIG. 6;

FIG. 8 is a perspective view showing the details of the third exemplary embodiment of the front face of the fluid ejector according to this invention;

FIG. 9 is a front view of a fourth exemplary embodiment of a front face of the fluid ejector according to this invention;

FIG. 10 is a front view of a fifth exemplary embodiment of a front face of the fluid ejector according to this invention;

FIG. 11 is a front view of a sixth exemplary embodiment of a front face of the fluid ejector according to this invention;

FIG. 12 is a front view of a seventh exemplary embodiment of a front face of the fluid ejector according to this invention;

FIG. 13 is a side view of a eighth exemplary embodiment of a fluid ejector according to this invention;

FIG. 14 schematically illustrates the channel and orifice structure of a ninth exemplary embodiment of a fluid ejector according to this invention;

FIG. 15 schematically illustrates a channel and orifice structure of a tenth exemplary embodiment of a fluid ejector according to this invention;

FIG. 16 schematically illustrates a channel and orifice structure of an eleventh exemplary embodiment of a fluid ejector according to this invention;

FIG. 17 schematically illustrates a channel and orifice structure of a twelfth exemplary embodiment of a fluid ejector according to this invention;

FIG. 18 is a flowchart outlining one exemplary embodiment of a method for forming a front face of a fluid ejector according to this invention;

### DETAILED DESCRIPTION OF EXEMPLARY EMBODIMENTS

The following detailed description of various exemplary embodiments of the fluid ejection systems according to this invention may refer to one specific type of fluid ejection system, a thermal ink jet print head, for sake of clarity and familiarity. However, it should be appreciated that the principles of this invention, as outlined and/or discussed below, can be equally applied to any known or later developed fluid ejection systems, beyond the thermal ink jet print head specifically discussed herein. Specifically, it should be appreciated that this invention is not limited to only those embodiments shown. In general, this invention can be used with any configuration, or any type of fluid ejector print head for which more accurate fabrication of the orifice structure is desirable.

In such fluid ejector heads, the fluid is allowed to flow through passageways in the fluid inlet in the fluid inlet or channel wafer and along fluid channels in the polymer layer and/or the fluid inlet or channel wafer until the fluid reaches the nozzles or orifices. In particular, the fluid passes over the positions along the heater wafer where the heaters are located. The passageways in the fluid inlet or channel wafer allow fluid from the fluid reservoir to be distributed into the many channels formed in the polymer layer and/or the fluid inlet or channel wafer.

On the other end of the channel from the fluid reservoir is an orifice structure from which the fluid droplets will be ejected and applied to a receiving medium, which is often paper. The fluid within the channels is expelled from the orifices when the heaters in the heater wafer are pulsed, creating a bubble of evaporated fluid, which expands. The unevaporated fluid in front of the bubbles is ejected from the orifices while the unevaporated fluid behind the bubbles is pushed backward toward the reservoir. After the end of the heating pulse, the fluid bubbles cool, collapse, and allow the channels to refill with fluid so that fluid ejectors will be ready for the ejection of the next droplets of fluid from the channels. The heater portion also has integrated addressing electronics and driver transistors.

Conventionally, thermal fluid jet print heads are fabricated by aligning the heater wafer that contains the heater elements with channels in the polymer layer and/or the fluid inlet or channel wafer. The channels may be formed in a variety of ways. The channels may be formed in the fluid inlet or channel wafer and may be formed by photo-lithographically defining the grooves, and then etching the grooves into the fluid inlet or channel wafer. The formed grooves may have varying shapes. For example, grooves may be by orientation dependent etching of a silicon fluid inlet or channel wafer having a (100) wafer orientation. In such a case, V-shaped grooves are formed. When the silicon fluid inlet or channel wafer is bonded to the other layers and/or wafers, the V-shaped grooves form triangular shaped channels. On the other hand, grooves may be formed that have sidewalls that are perpendicular to the wafer surface. In such cases, bonding the fluid inlet or channel wafer to the other layers and/or wafers forms rectangular channels. Because the channels are frequently formed in the fluid inlet or channel wafer, this wafer is often also called the channel wafer.

Although the channels are frequently formed in the fluid inlet wafer, the channels may additionally or alternatively be formed in the polymer layer. The channels formed in the polymer layer may be the same shape as grooves formed in the fluid inlet wafer, such as grooves with sidewalls forming substantially rectangular shaped channels when the wafer structure is formed. In fact, the shape of the channels can be any desired known or later-developed shape.

Whether formed in the fluid inlet wafer and/or in the polymer layer, channels may be formed using various techniques. In the case of silicon fluid inlet wafers, etching techniques, such as reactive ion etching (RIE), may be used to form the channels. When reactive ion etching is used as the etching technique, grooves with perpendicular sidewalls and rectangular shaped channels are formed. In the case of polymer layers, the etching technique may be used alone or in conjunction with other techniques, such as masking. In polymer layers, the polymer layer itself may be photosensitive so that the channels may be formed by developing the photo-exposed and patterned polymer layer.

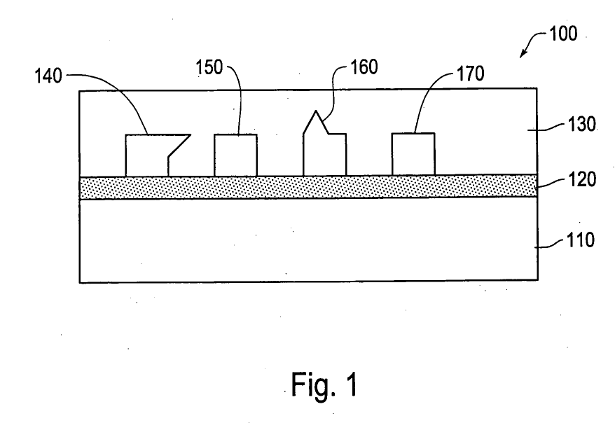

FIG. 1 shows some examples of defects in an orifice that are caused when the wafer structure is diced. As shown in FIG. 1, a fluid ejector print head 100 includes a heater wafer 110 containing bubble-nucleating heaters and related electronics, a polymer layer 120 placed on or over the heater wafer 110, and an fluid inlet wafer 130, which is bonded to the polymer layer 120. FIG. 1 shows four orifices 140, 150, 160 and 170, that are the termini of the fluid channels (not shown) formed in the fluid inlet wafer 130. In such fluid ejector print heads 100, the fluid is allowed to flow through a fluid inlet in the fluid inlet wafer 130 and along fluid passageways (not shown) in the polymer layer 120 and/or the fluid inlet layer 130 until the fluid reaches a point along the fluid channels (not shown) where the heaters (not shown) on the heater wafer 110 are located.

The fluid within the channels formed in the fluid inlet wafer 130 is expelled from the orifices 140-170 when the heaters in the print head 100 are heated, creating bubbles of evaporated fluid, which expand, ejecting the fluid in front of the bubble from the orifices 140-170. The heater wafer 110 may be formed from various materials, but it is typically formed using silicon. However, front face dicing of the fluid inlet wafers or channels 130, when, for example, the fluid inlet wafer 130 is a silicon wafer, has disadvantages. For example, the abrasiveness of the dicing operation often causes the brittle silicon wafer material near the channels to break away, causing defects, such as chipping, in the orifices 140-170. As shown in FIG. 1, the orifices 140 and 160 are chipped.

The chipped orifices 140 and 160 degrade device performance. For example, the chipped orifices 140 and 160 cause the fluid ejector print head 100 to be less accurate than one without chipped orifices, such as the orifices 150 and 170, because fluid droplets ejected from the chipped orifices 140 and 160 tend to be misdirected in directions according to the location and size of the chip. For instance, for the chipped orifice 140, the ejected fluid will be directed toward the right side of the figure, while for the chipped orifice 160, the ejected fluid will be directed to the top side of the figure. Therefore, unlike the unchipped orifices 150 and 170, whose fluids will tend to eject perpendicularly to the front face, fluids ejected from the chipped orifices 140 and 160 will be ejected at a skewed angle to the front face. Fluid ejected from the chipped orifices 140 and 160 will fail to hit the receiving medium where intended. The result of chipped orifices 140 and 160 is less accurate placement of each ejected fluid droplet on the receiving medium and degraded performance of the device that uses the fluid ejector with chipped orifices 140 and 160.

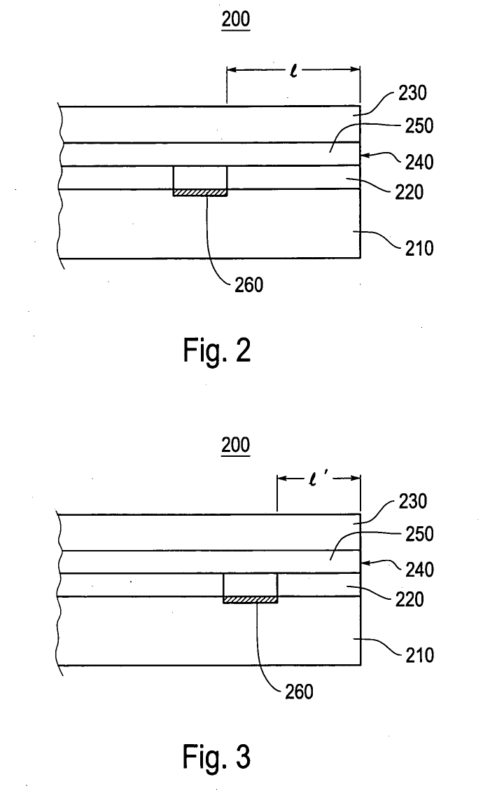

FIGS. 2 and 3 schematically illustrate two other examples of inaccurate dicing results. FIGS. 2 and 3 each show a side cross-sectional view of a fluid ejector head 200 comprising a heater wafer 210, a polymer layer 220, and a fluid inlet wafer 230. An orifice 240 is a terminus of a channel 250 formed in the fluid inlet wafer 230. A heater element 260 that heats fluids to form, and then eject, fluid droplets is located within the heater wafer 210. In the fluid ejector head 200 shown in FIG. 2, the orifice 240 is a distance 1 from the heater element 260. In contrast, in the fluid ejector 200 shown in FIG. 3, the orifice is a distance 1′ from the heater element 260.

The difference in the distances 1 and 1′ is caused, for example, by inaccurate dicing when flexible blades are used in an attempt to minimize chipping. The flexible blades, which have small diamonds embedded in a flexible resin mix, are prone to cause position errors during the dicing operation because such flexible blades tend to bend slightly when pressure is applied during dicing of the fluid ejector heads. Therefore, some dicing operations tend to create orifices 240 that are formed further from the heating elements 260 in the heater wafer 210, while other dicing operations tend to create orifices 240 that are formed nearer to the heating elements 260 in the heater wafer 210.

Such differences have significant effects on the accuracy of the fluid ejector print head because fluid volume and velocities are affected, and differ from each die and/or from each orifice. When an orifice is formed further from the heating element, the volume and the velocities of the ejected fluid droplet may decrease. The change in the fluid volume and velocities of an ejected fluid droplet make accurate and consistent fluid ejection difficult, leading to lower quality fluid ejector print heads.

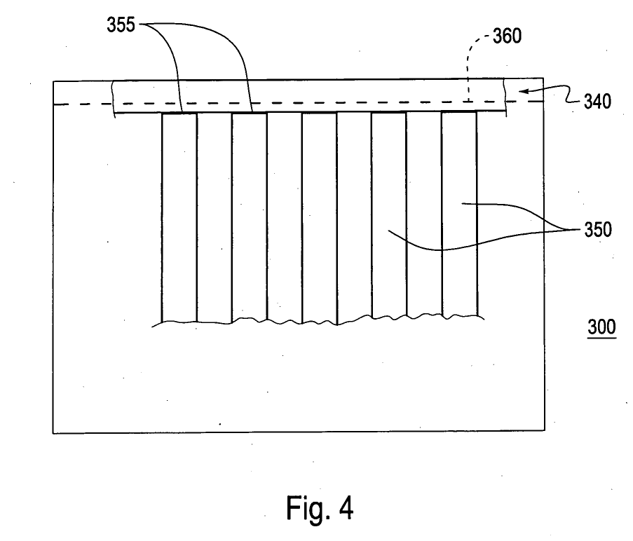

FIG. 4 shows the general structure of a first exemplary embodiment of a channel wafer formed according to this invention. FIG. 4 shows a top view of a channel wafer 300 having a plurality of channels 350. A cross trench 340 is formed near the terminus of the channels 350. The cross trench 340 communicates with each of the plurality of channels 350. The orifices 355 of the channels 350 are formed where the cross trench 340 intersect the channels 350. The cross trench 340 allows accurate formation and/or placement of the orifices 355 relative to the length of the channels 350. Further, the cross trench 340 avoids the need for any dicing blades to contact the channels 350 or the orifices 355, and thus tends to reduce the formation of defects in the orifices 355. The dotted line 360 in FIG. 4 shows the cut placement of a subsequent dicing operation after the wafers are bonded together. In this embodiment, both the channels 350 and the cross trench 340 have been formed with substantially the same depth h.

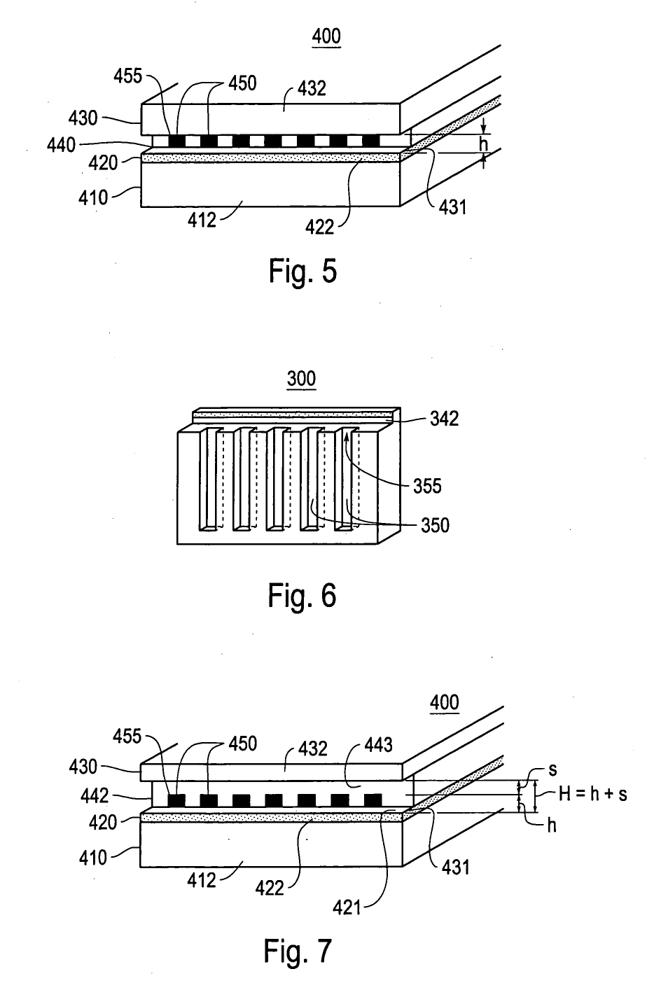

FIG. 5 shows a general structure of a first exemplary embodiment of a front face of a fluid ejector 400 that incorporates the channel wafer 300 shown in FIG. 4. The fluid ejector 400 includes a channel wafer 430 that is placed on or over a polymer layer 420, which is in turn placed on or over a heater wafer 410. In the exemplary embodiment shown in FIG. 5, the channels 450 are formed in the channel wafer 430. An orifice 455 terminates each channel 450. In the exemplary embodiment shown in FIG. 5, the faces 412, 422 and 432 of the heater wafer, the polymer layer 420 and the channel wafer, 430 respectively, are formed by dicing in front of the plane of the orifices 355 shown in FIG. 4. As a result, the orifices 455 lie in a trough 440 which is the remnant of the cross trench 340 In particular, the trough 440 is formed only part way into the channel wafer 430 of the fluid ejector 400, such that a portion of the thickness of the channel wafer 430 having the diced face 432 remains after the trough 440 is formed.

In the exemplary embodiment shown in FIG. 5, the trough 440 has a height h between the top surface of the polymer layer 420 and the surface of the remaining portion of the channel wafer 430 having the diced face 432. In particular, in the exemplary embodiment shown in FIG. 5, the height h of the trough 440 is substantially same to the height of the channels 450. In this exemplary embodiment, the channels 450 and the cross trench 340, whose remnant is the trough 440, are formed as grooves in a surface 431 of the channel wafer 430 that contacts the polymer layer 420. Forming the cross trench 340 along with the channels 350 in FIG. 4. and 450 in FIG. 5. in the channel wafer 430 exposes the orifices 455 inside the trough 440.

However, the height h of the cross trench 340 and resulting trough 440 need not be limited to that shown in FIG. 5. For example, FIGS. 6 and 7 show another exemplary embodiment of the front face of a fluid ejector according to this invention. Specifically, FIG. 6 shows the general structure of a second exemplary embodiment of a channel wafer 300 formed according to this invention and FIG. 7 shows a general structure of a front face of the fluid ejector shown in FIG. 6.

FIG. 6, shows a top view of the channel wafer 300 and a plurality of channels 350. A second exemplary embodiment of a cross trench 342 is formed near the terminus of the channels 350. The cross trench 342 intersects the plurality of channels 350. Orifices 355 are formed where the cross trench 342 intersect the channels 350. In this embodiment, the cross trench 342 is formed such that the height H of the cross trench, and thus that of the resulting trough as shown in FIG. 7, is greater than the height h (as shown in FIG. 7) of the channels 350. For example, if the channel grooves 350 are to be formed to a depth h by reactive ion etching, then the deeper cross trench could be formed by a first etch to a depth s and then, after removing the masking corresponding to the channel grooves etching an additional depth h together with the channel grooves.

In the exemplary embodiment shown in FIG. 7, the fluid ejector 400 includes the channel wafer 430 that is placed on or over the polymer layer 420, which is in turn placed on or over the heater wafer 410. As shown in FIG. 7, the channels 450 are formed in the channel wafer 430. An orifice 455 terminates each channel 450. In the exemplary embodiment shown in FIG. 7, the cross trench 342 shown in FIG. 6 and the resulting trough 442 is formed only in the channel wafer 430. The diced faces 412, 422 and 432 are in front of the plane of the orifices 455, so that the orifices 455 lie in the trough 442. Further, the channels 450 are formed similarly to the channels 450 as discussed above for FIG. 5.

The height H of the cross trench 342 and the resulting trough 442 is equal to the height h of the channels 450 plus the height s of the portion of the trough 442 between the surface 443 of the portion of the channel wafer 430 having diced face 432 and the top of the orifice 450. That is, the height H of the trough 442 is greater than the height h of the orifice 450 by a given height s. This configuration has the advantage that the top of the orifice is in the same plane as the sides of the orifice.

In this exemplary embodiment, the exact height H and the corresponding heights h and s, may be modified without departing from the spirit of the embodiment. Furthermore, the height H may be further defined by also forming a cross trench in either a portion of the polymer layer 420 or cross trenches in both the polymer layer 420 and in the heater wafer 410 to form a resulting trough.

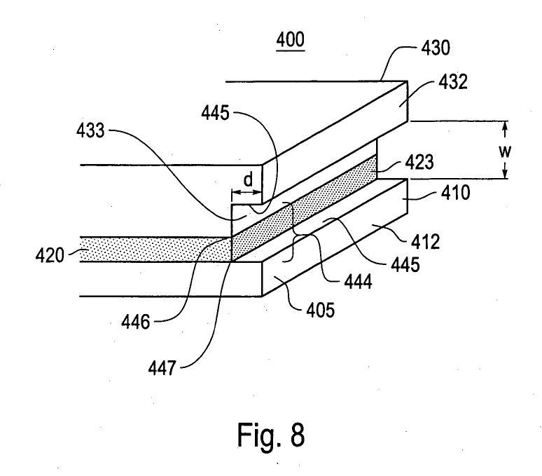

For example, FIG. 8 is a perspective view showing the details of a third exemplary embodiment of the front face of the fluid ejector according to this invention, where an indentation 433 in the channel wafer 430 is combined with an indentation 423 formed in the polymer layer 420 to form a trough 444. As shown in FIG. 8, the fluid ejector 400 includes the channel wafer 430 placed on or over the polymer layer 420, which is also placed on or over the heater wafer 410. In this embodiment, the polymer layer 420 has been patterned to have a front edge that is coincident with the plane of orifices when the channel wafer is subsequently placed on the polymer layer and the heater wafer. The fluid ejector has a formed front face 405 that includes the diced surface 412 of the heater wafer 410 and the diced surface 432 of the channel wafer 430. The dice cut or cuts used to form surfaces 412 and 432 are in front of the plane of orifices 446 so that the orifices lie in a trough 444.

In the exemplary embodiment shown in FIG. 8, the trough 444 has depth d between the front face 405 and the plane of the orifices 446 and a width w between the trough side walls 445. The depth d is equal to the distance that the dice cut is placed in front of the plane of orifices 446. In the exemplary embodiment shown in FIG. 8, the trough 444 is formed in a portion of the channel wafer 430 and through the entire thickness of the polymer layer 420. However, in some variations of this third exemplary embodiment, the trough 444 may extend through the entire thickness of the polymer layer 420 and partially into the thickness of the heater wafer 410. Such an extension into the heater wafer would be formed, for example, by reactive ion etching a trench into the heater wafer before the channel wafer is placed on or over the heater wafer.

The various exemplary embodiments of the systems, methods and fluid ejector devices of this invention are not limited to any particular number of indentations, trenches and/or troughs formed in the fluid ejector or in each of the various wafers or layer, or any combination of such indentations, trenches and/or troughs.

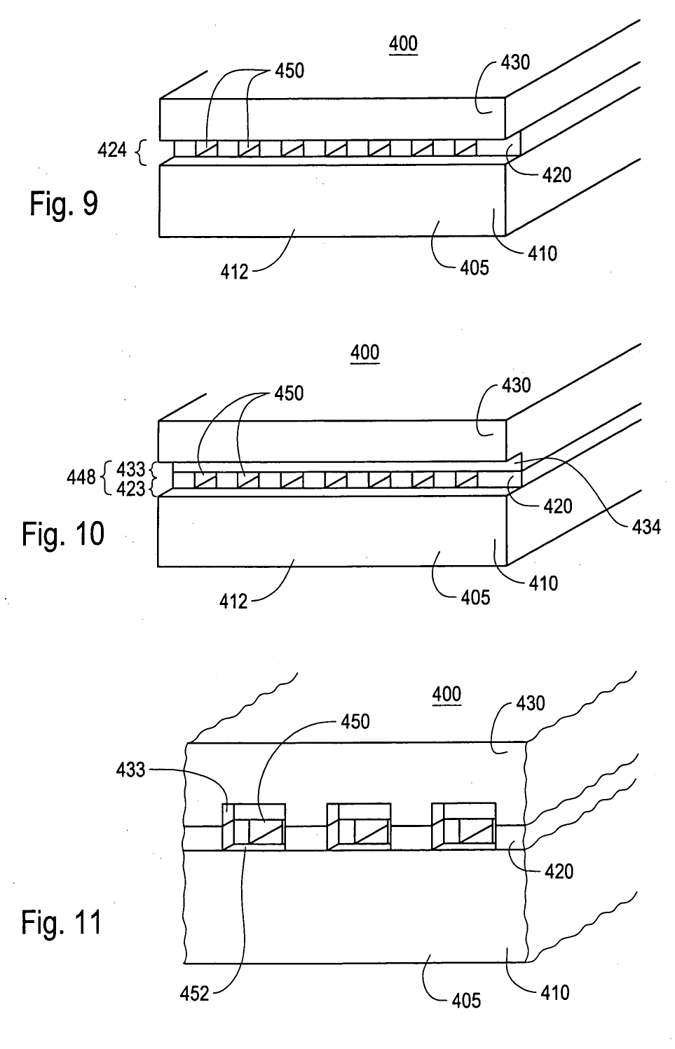

FIG. 9 shows a front view of a fourth exemplary embodiment of a front face of the fluid ejector 400 according to this invention. As shown in FIG. 9, the orifices 450 of the fluid ejector 400 are formed only within the polymer layer 420, and not formed in the other layers, i.e., the heater wafer 410 or the channel wafer 430. By dicing the faces of the heater wafer 410 and the channel wafer 430 in front of the front edge of the polymer layer 420 and the resulting orifice plane, the orifices 455 lie in a trough 424. In this embodiment, in the trough 424 is formed only in the polymer layer 420 and only extends within the polymer layer 420.

Although FIG. 9 shows the orifice 450 occupying the entire thickness of the polymer layer 420, the orifice 450 may alternatively only occupy a portion of the thickness of the polymer layer 420. For example, the orifices 450 formed in the polymer layer 420 may be formed shifted more towards the heater wafer 410 or formed shifted more towards the channel wafer 430. Alternatively, the orifices 450 may be formed in substantially the middle portion of the polymer wafer 420, allowing gaps to exist between the orifices 450 and the side walls of the trough 424 formed in the polymer layer 420. In such embodiments, the polymer structure 420 may be formed by successive patterning of polymer layers or by bonding together two polymer layers with respective grooves that form a fluid channel when bonded.

FIG. 10 is a front view of a fifth exemplary embodiment of a front face of the fluid ejector according to this invention where the fluid ejector 400 includes the heater wafer 410, the polymer layer 420 placed on or over the heater wafer 410, and the channel wafer 430 placed on or over the polymer layer 420. The fluid ejector 400 includes a trough 448 formed by an indentation 423 formed in the polymer layer 420 and an indentation 433 formed into a portion 434 of the channel wafer 430 at the front face 405. In this exemplary embodiment, the orifice 450 is formed in the polymer layer 420, which lies entirely within the trough 448. Nevertheless, in the illustrated exemplary embodiment shown in FIG. 10, the portion 434 of the trough 448 that is formed within the channel wafer 430 is formed, for example, by etching a trench in the channel wafer 430 in a location designed to line up subsequently with the orifices 450 in the polymer layer 420 when the channel wafer 430 is placed over the polymer layer 420 and heater wafer 410.

Although FIG. 10 shows an embodiment where the indentation 423 extends through the polymer layer 420 and the indentation 433 extends only partially into the channel wafer 430 at the front face 405, alternate embodiments may have the indentation 423 only partially extending into the polymer layer. Although FIG. 10 shows that the orifices 450 are entirely formed within the polymer layer 420, in other exemplary embodiments, the orifices 450 may be partially formed in both the channel wafer 430 and the polymer layer 420. The orifices 450 may also be formed to extend into the heater wafer 410.

FIG. 11 is a front view of a sixth exemplary embodiment of a front face of the fluid ejector according to this invention. FIG. 11 also shows a fluid ejector 400 with a channel wafer 430 placed on or over a polymer layer 420, which is formed over the heater wafer 410. In exemplary embodiment shown in FIG. 11, each orifice 450 is formed within an individual trough 452 formed by an indentation 423 formed in the polymer layer 420 and indentation 433 formed in the channel wafer 430.

In the sixth exemplary embodiment, as shown in FIG. 11, each orifice 450 is formed only within the polymer layer 420. Each individual trough 452 is substantially square in shape. However, in various exemplary embodiments, the orifice 450 may be formed in the heater wafer 410, the channel wafer 430, or any combination of the heater wafer 410, the channel wafer 430, and the polymer layer 420. Therefore, the individual troughs 452 may partially extend into both the heater wafer 410 and the channel wafer 430 and also through the polymer layer 420 (as shown), or may be formed in only two of the three wafers and layers 410, 420 and 430. In other various exemplary embodiments, the shape of individual trough 452 may be rectangular, as shown in FIG. 11, or may be triangular, circular, hexagonal, or any other appropriate desired shape. In other various exemplary embodiments, two or more orifices 450 may be formed within each individual trough 452. In general, the fluid ejector 400 will contain more than one such trough 452.

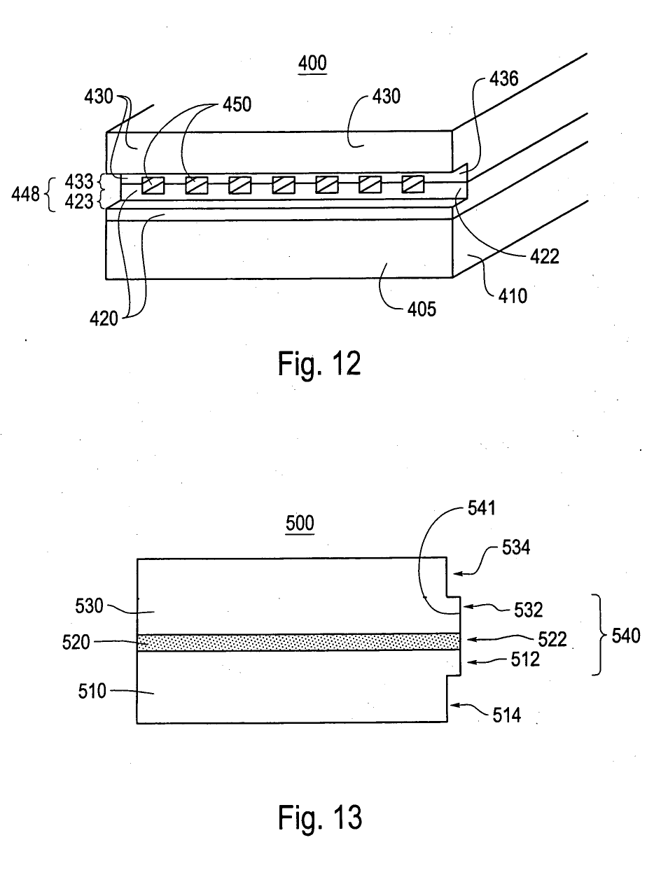

FIG. 12 is a front view of a seventh exemplary embodiment of a front face of the fluid ejector according to this invention. The fluid ejector 400 includes a heater wafer 410, polymer layer 420, and a channel wafer 430. A second exemplary variation of the trough 448 is formed by combining an indentation 433 formed in the channel wafer 430 and an indentation 423 formed in the polymer layer 420. The surface 436 forms the floor of the indentation 433 formed in the channel wafer 430, and the surface 422 forms the floor of the indentation 423 formed in the polymer layer 420.

The orifice 450 is formed both in the channel wafer 430 and the polymer layer 420. In this exemplary embodiment, the channel wafer 430 and the polymer layer 420 each have a portion of the orifice 450. The orifice 450 may be formed such that most of the orifice 450 is formed in the channel wafer 430 or vice versa. In various exemplary embodiments, the orifice 450 may be formed entirely in only one of the wafers or layers 410, 420 or 430.

In the various exemplary embodiments, including those shown in FIGS. 4-12, the front face 405 can be formed by a dicing operation using a blade with small diamonds imbedded in a flexible resin mix, or the like. The blade is used to dice through each of the three primary wafers and layer, i.e., the channel wafer 430, the polymer layer 420, and the heater wafer 410, and the trough(s) 440, 442, 444, 448 or 452 formed in one or more of those layers, to form the front face 405. In the various exemplary embodiments shown, FIG. 8 being only an example, the orifice plane 446 is set back from the front face 405 by a distance d, which is the distance of the dice cut in front of the orifice plane 446. Therefore, the troughs 440, 442, 448, and 452, such as the trough 444 shown in FIG. 8, create an indentation into the front face 405 of the fluid ejector head module 400.

In conventional fluid ejectors, the dicing operation often causes chipped orifices at the front face of the fluid ejectors. In the exemplary embodiments shown, for example, in FIG. 8, the orifices 450 are formed in the orifice plane 446 of the trough 444 and are therefore set back from the front face 405 that is created by the dicing operation. Consequently, dicing blades do not contact the orifices 450, and chipping of the orifices 450 is reduced.

The cross trench corresponding to the trough 440, 442, 444, 448 or 452 may be formed by any appropriate forming operation. For example, in some exemplary embodiments where the cross trenches are formed in a well-defined photosensitive polymer layer, such as SU-8, the cross trenches corresponding to the trough 440, 442, 444, 448 or 452 may be photo-lithographically defined and developed. In other embodiments, the channels may be first photo-lithographically defined, and then etched. Various wet and dry etching techniques may be used in various exemplary embodiments. In various exemplary embodiments, to form well-defined sidewalls, dry etching such as reactive ion etching (RIE) may be used to form the cross trench corresponding to the trough 440, 442, 444, 448 or 452.

Reactive ion etching (RIE) is a relatively slow process. Typical time frames for etching channels with depths of 20 microns may be one hour. Therefore, RIE may not be effective for etching through an entire wafer sandwich that may be formed by heater wafers 410 that are 600 microns thick, polymer layers 420 that are 10 to 20 microns thick, and channel wafers 430 that are about 500 microns thick. The exact depth h of the trench shown in FIG. 5 or the exact depth H=h+s of the trench shown in FIG. 6 which is to be etched will depend on processing concerns such as accuracy, time, cost, and manufacturing throughput. In various exemplary embodiments, the cross trench 440, 442, 444, 448 or 452 and/or the indentations 423 and 433 may be formed to a depth between 0 to 100 microns.

In the exemplary embodiments shown in FIGS. 4-12, and outlined above, the orifices 450 lie within a trough which is recessed a distance d behind the diced faces. In some exemplary embodiments, depending on trough and orifice geometry, as well as on the surface wetting properties of the trough, orifice and channel, and/or on the surface tension of the fluid, a shallow pool of fluid can fill the trough. This can be a disadvantage for fluid ejection behavior in some applications. There is another class of front face geometries made possible by a cross trench whose width w is greater than the channel height h, such that the die may be separated from the wafer and without the dicing blade contacting the orifice face, and yet have the orifice face be the frontmost face of the device. FIG. 13 shows a side view of an eighth exemplary embodiment according to this invention, which is an example of the class of front face geometries where the orifice face is frontmost. The structure in FIG. 13 is formed in similar fashion to that shown in FIG. 8, but includes an additional trench (not shown) in the heater wafer. In this exemplary embodiment, instead of the dice cut position being in front of the orifice face, the dice cut position is located behind the orifice face. The dicing depth is such that the blade enters the cross trench, but only to a depth that is outside of the region of the orifice faces. It should be appreciated that, in these exemplary embodiments, dicing is a two step process. That is, the dice cut from the top of the channel wafer does not penetrate as deep as the top of the orifices. Similarly, the dice cut from the bottom of the heater wafer does not penetrate as deep as the bottom of the orifices.

FIG. 13 shows a fluid ejector 500 that includes a heater wafer 510, a polymer layer 520 and a channel wafer 530 that form the fluid ejector 500. The fluid ejector 500 is formed with an extended portion 540 that includes a portion 532 formed in the channel wafer 530, a portion 522 formed in the polymer layer 520, and a portion 512 formed in the heater wafer 510. As shown in FIG. 13, the extended portion 540 extends away from, i.e., is offset from, a face 534 formed in the channel wafer 530 and a face 514 formed in the heater wafer 510. The orifice faces (not shown) are at the surface of the extended portion 540.

One exemplary method of forming the fluid ejectors 500 shown in FIG. 13 is to first form cross trench in the channel wafer 530, the heater wafer 510 and the polymer layer 520 in locations such that the cross trenches generally line up when the channel and heater wafers 510 and 530 and polymer layer 520 are bonded together. Thereafter, the wafers 510 and 530 and the polymer layer 520 are bonded together to create a buried trench structure (not shown) having a side wall 541. The surface of the heater wafer 510 should be visible in specific dicing alignment locations via through-holes (not shown) etched, for example, in the channel wafer 530. Using these alignment locations on the heater wafer 510, dicing cuts are made through the top of the channel wafer 530, but at least slightly behind the surface 541, using a dicing blade to dice deeply enough through the channel wafer 530 to intersect the buried trench structure, but not so deep as to intersect the orifices 550.

Subsequently, the bonded together wafer structure is turned over and a second cut is made through the heater wafer 510 sufficiently deeply to intersect the cross trench in the heater wafer 510, thus completing the front face dicing operation. Because the dicing blade was not used to form the face 541, but was merely used to expose the face 541 of the buried trench structure, the orifices are not contacted by, and thus are not directly damaged by, the dicing blade.

In various exemplary embodiments, small errors in wafer and layer alignment and bonding may occur, and a discontinuity up to the order of 3 microns between the portion of the cross trench 542 formed in the channel wafer 530 and the portion of the cross trench 542 formed in the heater wafer 510 may form. In various exemplary embodiments, if desired, this discontinuity may be removed by a subsequent touch-up operation.

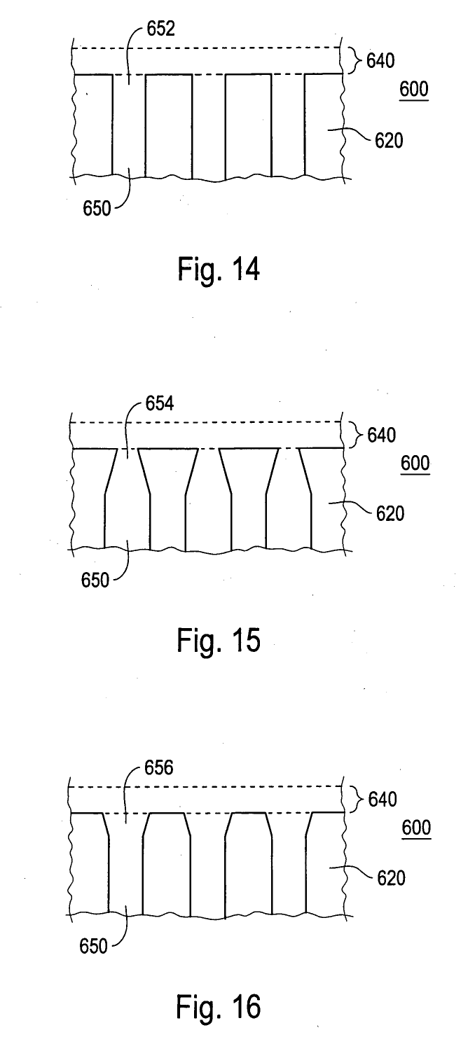

FIGS. 14-17 schematically illustrate various exemplary embodiments of channel and orifice structures usable in a fluid ejector according to this invention. FIGS. 14-17 show various exemplary embodiments of orifice structures 652-658 formed at the ends of the channels 650 within a desired layer such as, for example, a polymer layer 620 of a fluid ejector 600. In the exemplary embodiment shown in FIG. 14, the orifice 652 is formed as the termini of each channel 650. That is, the orifices 652 have the same cross-sectional shape and size as the channels. Although shown as formed in the channel wafer 620, the channels 650 and the orifices 652-658 may be formed in at least one of the polymer layer (not shown), the channel wafer 620 and/or the heater wafer (not shown).

In the exemplary embodiment shown in FIG. 14, the orifices 652 are formed at a desired distance from a heater element (not shown) in the fluid ejector. That is, as discussed above, the orifice is formed not by the dicing operation, but by forming the cross trench 640.

In the exemplary embodiment shown in FIG. 15, an orifice 654 tapers near the end of the channel 650, just before the cross trench 640. The dimensions of the orifice 654 are thus smaller than the dimensions of the channel 650. In various embodiments, each orifice 654 may be identical in dimension because the orifices 654 were formed by the formation of the cross trench 640, rather than by using a dicing operation to form the front face. Therefore, such consistently formed tapering orifices 654 allow more accurate volume and velocity control of the fluid droplets to be obtained from each of the orifices 654.

The tapered orifices 654 can be formed using various techniques, such as, for example, reactive ion etching the channel 650 into the channel wafer 620. The desired narrowing of the channel 650 can be achieved where the cross trench 640 is expected to be formed to create the orifice 650, prior to wafer bonding.

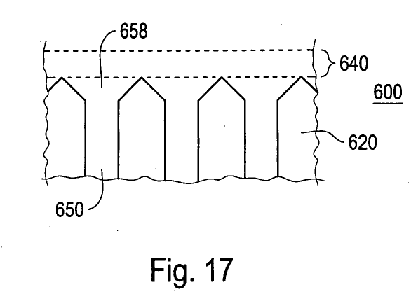

In the exemplary embodiment shown in FIG. 16, the orifices 656 are formed in the channel wafer 620 so that the orifices 656 flare out near the end of the channel 650. The dimensions of the orifices 656 are thus larger than the dimensions of the channel 650. In the exemplary embodiment shown in FIG. 17, the channels 650 are formed closer to each other so that the flared orifice 656 are just touching one another.

In various exemplary embodiments, some of the orifices 650 may be tapered, while the orifices of other channels 650 in the same fluid ejector 600 may be flared. In various exemplary embodiments, the orifices of other channels 650 that are not gradually tapered but have an abrupt step-like structure.

In various exemplary embodiments described above, the orifices 652-658 are not damaged by a dicing operation because the cross trench 640 allows the orifices 652-658 to be formed away from the front face. Further, the orifices 652-658 can be formed and placed accurately at a desired position in the fluid ejector 600 because the exact placement of the orifice 652-658 from the heater elements can be controlled when forming the cross trench 640.

In various exemplary embodiments, the variously shaped orifices 652-658 allow fluid droplet volume and velocity to be more accurately controlled by varying the shape of the orifice, for instance by allowing the tapered orifices 652-658 shown in FIG. 15 to act like a nozzle. Forming the cross trench 640 determines the exact placement of the orifices 652-658 in relationship to the heater elements or other structures in the fluid ejector device. In various exemplary embodiments, techniques such as reactive ion etching (RIE) can be used to forms orifice structures that allow each of the orifices to be substantially consistent in their performance.

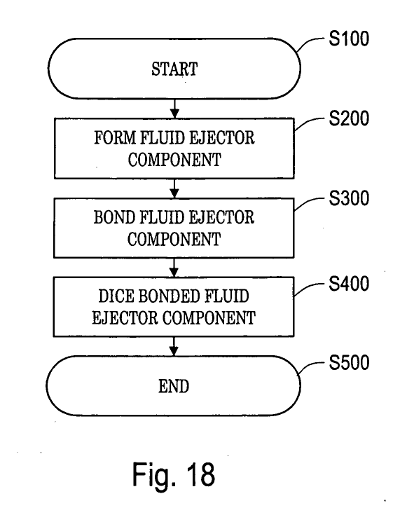

FIG. 18 is a flowchart outlining one exemplary embodiment of a method for forming an exemplary embodiment of a fluid ejector according to this invention. Starting in step S100, operation continues to step S200, where at least one desired fluid ejector component is formed. The at least one desired fluid ejector component is one or more of the channel and/or heater wafers and/or the polymer layer, or other layers, comprising the fluid ejector. In step S200, the channels in the channel wafer and/or the polymer layer (or other layers) may be formed in a variety of ways, such as by photo-lithographically defining grooves in the channel wafer and/or the polymer layer. In step S200 cross trenches and/or indentations may be formed in a desired layer and/or wafer. Other techniques, such as reactive ion etching (RIE) etching are possible. When reactive ion etching (RIE) is used as the etching technique, channels with perpendicular sidewalls and rectangular shaped channels may be formed in the channel wafer and/or the polymer layer. In exemplary embodiments of the fluid ejector devices that are polymer layers, the etching technique may be used alone or in conjunction with other techniques such as masking, and/or the layers itself may be photosensitive so that the pattern may be developed after photo exposure.

In step S300, the channel and heater wafers and the polymer layer, as well as any other layers, of the fluid ejector device are bonded together. Bonding the channel and heater wafers and the polymer layer defines the channels and buries the cross trench. Next, in step S400, the bonded channel and heater wafers and the polymer layer are diced into individual fluid ejector devices. As part of the dicing operation, a dicing blade or other dicing device or technique is used to intersect the cross trench formed within the bonded wafers and layers. Because the orifices were already formed and open into the indentations, the dicing operation does not form the orifices and the dicing blade (or other dicing device or technique) does not even interact with the previously formed orifices. The dicing operation separates the individual fluid ejectors and creates the front face of the fluid ejector devices. The dicing cut position may be designed to be in front of the orifice faces, such that the orifice faces are in a trough in the front face. Alternatively, the dice cut position may be designed to be behind the orifice face so that the orifice faces are at the frontmost part of the device. In either case, the dicing blade does not hit the orifice faces. This allows additional options in the choice of dicing blade type, and high quality orifice faces are obtained. For example, stiffer blades may be used which bend less, wear less, and can be run at higher feed speed, which tends to improve dicing throughput. Operation then continues to step S500, where operation of the method ends.

The various exemplary embodiments described above are equally applicable to devices having two primary layer structures such as piezo-electric ejectors.

1. A method for forming fluid ejector devices, comprising:
forming channels in at least one of a first wafer, a second wafer and zero, one or more intermediate layers;
forming at least one cross trench on at least one of the first and second wafers and the zero, one or more intermediate layers, that interacts the formed channels to form orifices for the channels;
combining the first and second wafers and the zero, one or more intermediate layers to form a wafer structure containing a plurality of fluid ejector devices;
forming front faces for the fluid ejector devices by dicing at least into the cross trenches such that the orifices are offset from the front faces.

2. The method of claim 1, wherein the orifices are set back from the front faces formed by dicing.

3. The method of claim 1 wherein the orifices extend in front of the front faces formed by dicing.

4. The method of claim 1, wherein the cross trench is formed by reactive ion etching.

5. The method of claim 1, wherein the channels are flared near the orifice.

6. The method of claim 1, wherein the channels are tapered near the orifice.

7. The method of claim 1, wherein forming front faces for the fluid ejector device by dicing at least to a depth that does not extend to the orifices.

8. A method for forming a fluid ejector device, comprising:
forming a heater wafer containing bubble-nucleating heaters and related electronics, a polymer layer, and a channel wafer;
forming at least one cross-trench structure in at least one of the heater wafer, the polymer layer, and the channel wafer that intersects the channels formed in at least one of the channel wafer, the polymer layer, and the heater wafer to form orifices for the channels;
bonding the channel wafer over the polymer layer, and the polymer layer over the heater wafer to form a bonded structure; and
forming a front face of the fluid ejector device by dicing at least into the at least one cross-trench of the bonded structure such that the orifices are offset from the front face.

9. The method of claim 8, wherein the at least one orifice is set back from the front face of the bonded structure formed by dicing.

10. The method of claim 8 wherein the orifices extend in front of the surfaces formed by dicing.

11. The method of claim 8, wherein the at least one cross-trench is formed by reactive ion etching.

12. The method of claim 8, wherein the channel is flared near the orifice.

13. The method of claim 8, wherein the channel is tapered near the orifice.

14. The method of claim 8, wherein forming front faces for the fluid ejector device by dicing at least to a depth that does not extend to the orifices.

15. A fluid ejector, comprising:
channels formed in at least one of a first wafer, a second wafer and zero, one or more intermediate layers;
at least one cross-trench formed in at least one of the first and second wafers at the zero, one or more intermediate layers that intersects the channels to form orifices for the channels, wherein the combination of the first and second wafers on the zero, one or more intermediate layers form a wafer structure containing a plurality of fluid ejector devices;
front faces formed for the fluid devices by at least dicing into the cross-trenches such that the orifices are offset from the front faces.

16. The fluid ejector of claim 15, wherein the orifices are set back from the front face formed by dicing.

17. The fluid ejector of claim 15, wherein the orifices extend in front of the surfaces formed by dicing.

18. The fluid ejector of claim 15, wherein the cross-trench is formed by reactive ion etching.

19. The fluid ejector of claim 15, wherein front faces are formed for the fluid devices by dicing at least to a depth that does not extend to the orifices.

20. A fluid ejector device, comprising:
a heater wafer containing bubble-nucleating heaters and related electronics;
a polymer layer;
a channel wafer;
at least one cross-trench formed in at least one of the heater wafer, the polymer layer, and the channel wafer that intersects the channels formed in at least one of the channel wafer, the polymer layer, and the heater wafer to form orifices for the channel, wherein the channel wafer is over the polymer layer, and the polymer layer is over the heater wafer to form a bonded structure; and
a front face formed by dicing at least into the at least one cross-trench of the bonded structure.

21. The fluid ejector device of claim 20, wherein the at least one orifice is set back from a front face of the bonded structure formed by dicing.

22. The fluid ejector device of claim 20, wherein the orifices extend in front of the front faces formed by dicing.

23. The fluid ejector device of claim 20, wherein the at least one cross-trench is formed by reactive ion etching.

24. The fluid ejector device of claim 20, wherein the channel is flared near the orifice.

25. The fluid ejector claim 20, wherein the channel is tapered near the orifice.

26. The fluid ejector of claim 20, wherein front faces are formed for the fluid devices by dicing at least to a depth that does not extend to the orifices.
